(19) United States
(12) Patent Application Publication
(10) Pub. No.: US 2026/0212335 A1
(43) Pub. Date: Jul. 23, 2026

(54) SYSTEMS AND METHODS FOR SECURE AUTOMATIC PAYMENT MODIFICATION

(71) Applicant: Wells Fargo Bank, N.A., San Francisco, CA (US)

(72) Inventors: Tosha Wesley Lyles, Charlotte, NC (US); Janet L. Koger-Nowlin, Charlotte, NC (US); Jeanette Imai, Saint Petersburg, FL (US); Rhea Francisco Rojo, Taguig (PH); Cecil B. Burrowes, Charlotte, NC (US); Christopher J. Starr, Columbus, OH (US); Christian Charisse Freeman, Charlotte, NC (US)

(21) Appl. No.: 19/034,195

(22) Filed: Jan. 22, 2025

(51) Int. Cl. G06Q 20/10; G06Q 40/02

(52) U.S. Cl. CPC G06Q 20/102; G06Q 40/02

(57) ABSTRACT

Systems, apparatuses, methods, and computer program products are disclosed for secure automatic payment modification. An example method includes generating an account onboarding experience (AOE) instance that facilitates communication between a user device and an onboarding system device. The example method further includes obtaining, via the AOE instance, former account data. The example method further includes obtaining selected account data. The example method further includes obtaining, via the AOE instance, first platform account data corresponding to a first external platform. The example method further includes automatically accessing, using the first platform account data, a first platform account associated with the first external platform. The example method further includes determining first existing automatic payment data for the first platform account. The example method further includes automatically modifying the first existing automatic payment data based on the selected account data.

### BACKGROUND

An individual may have many user accounts across different platforms for various services (e.g., utility services, streaming services, etc.). These user accounts may be configured for automatic payment (i.e., autopay) and draw from different payment methods such as bank account drafts, credit cards, or debit cards. Keeping track of how each of these accounts are configured can be challenging, especially when migrating to one or more new accounts.

### BRIEF SUMMARY

As the digital landscape of today becomes increasingly fragmented, individuals find themselves having to create separate user accounts for seemingly every service platform they interact with. These platforms include, for example, utility services (e.g., electricity companies, natural gas companies, water companies, etc.), entertainment services (e.g., video and/or music streaming services), meal delivery services, gym memberships, cloud storage services, software subscriptions, gaming subscriptions, monthly parking, and the like. With each of these user accounts requiring its own set of credentials, payment methods, and settings, users are often left without a clear view of active subscriptions and billing obligations. These complexities can often result in events such as surprise automatic drafts to accounts users were not expecting.

When switching from an old banking account to a new banking account, users may wish to update their existing account or billing information for various subscriptions, vendors, employers, and the like to reflect the new banking account. However, currently, users must manually identify each user account that requires an update and then perform the update themselves (e.g., through a multitude of websites for each platform). This results in a time-consuming and burdensome process for users.

Additionally, users may switch banks or close existing payment accounts for various reasons. However, closing or deactivating these accounts may be risky to the user if they are used in certain autopay enrollments. Users may forget which payment account is used for a particular subscription account, and why that payment account is used for that particular subscription account (e.g., a fee reduction for direct bank draft, points or rewards for credit card usage, etc.).

In contrast to these conventional, manual, and tedious techniques, example embodiments described herein provide secure automatic payment modification. Example embodiments streamline the process of updating payment methods across a multitude of platforms (e.g., third-party platforms) by automatically accessing platforms via an application programming interface (API) using user-supplied credentials and updating autopay settings to reflect new or different accounts. By doing so, the need for users to manually log in to each of their many user accounts and update payment configurations is eliminated, while the risk of missed payments or service interruptions due to inaccurate or outdated payment data is greatly reduced. Additionally, computer functionality is improved through the automation of complex payment configuration processes that traditionally require extensive manual intervention. Through leveraging secure mechanisms for obtaining credentials and APIs, computational overhead (e.g., in the form of redundant tasks such as repeated logins, re-authentication, data input, and bandwidth consumption) is greatly reduced.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying an onboarding system device that may perform various operations in accordance with some example embodiments described herein.

FIG. 3 illustrates an example flowchart for secure automatic payment modification, in accordance with some example embodiments described herein.

FIG. 4 illustrates an example flowchart for facilitating communication via a language model, in accordance with some example embodiments described herein.

FIG. 5 illustrates an example flowchart for secure automatic payment modification, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

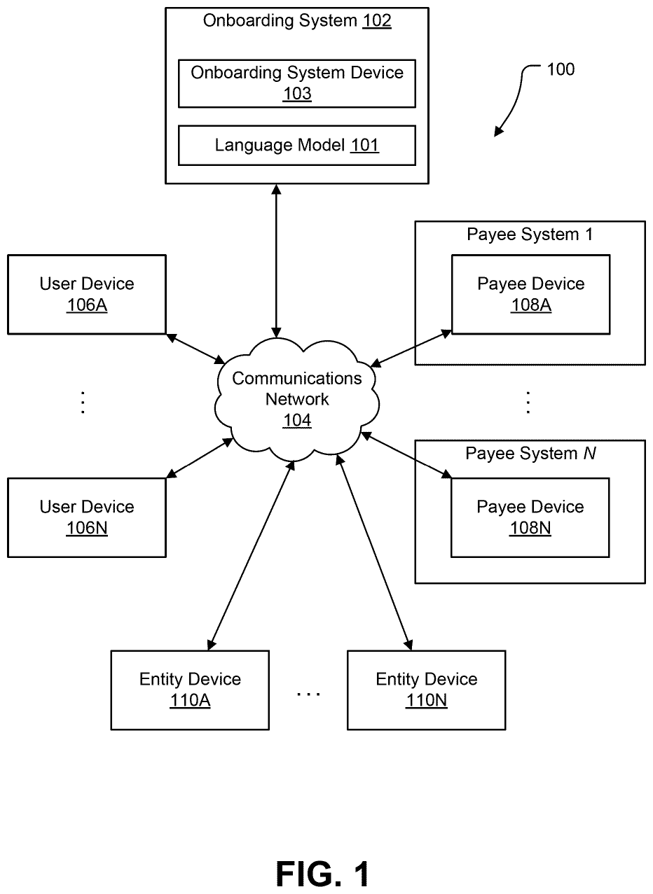

Example embodiments described herein may be implemented using any of a variety of computing devices or servers. To this end, FIG. 1 illustrates an example environment 100 within which various embodiments may operate. As illustrated, an onboarding system 102 may receive and/or transmit information via communications network 104 (e.g., the Internet) with any number of other devices, such as one or more of user devices 106A-106N, payee devices 108A-108N, and/or entity devices 110A-110N.

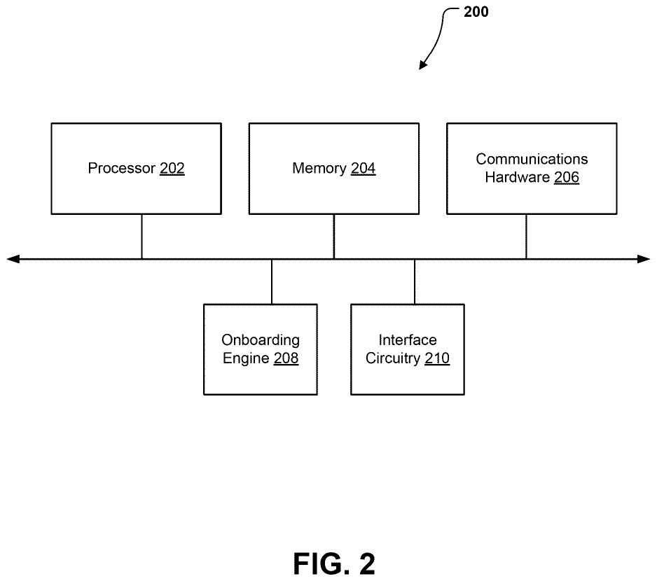

The onboarding system 102 may be implemented as one or more computing devices or servers, which may be composed of a series of components. Particular components of the onboarding system 102 are described in greater detail below with reference to apparatus 200 in connection with FIG. 2.

In some embodiments, the onboarding system 102 may include a storage device that comprises a distinct component from other components of the onboarding system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the onboarding system 102 and may store information relied upon during operation of the onboarding system 102, such as various data that may be used by the onboarding system 102, a language model 101, or the like. In addition, storage device 106 may store control signals, device characteristics, and access credentials enabling interaction between the onboarding system 102 and one or more of the user devices, 106A-106N, payee devices 108A-108N, and/or entity devices 110A-110N.

In various embodiments, onboarding system 102 may comprise a language model 101 used to gather data from one or more users by prompting users and interpreting user responses to prompts. In various embodiments, language model 101 may comprise a large language model (LLM). Language models (such as large language models (LLMs)) may be effective to semantically interpret natural language inputs using the parametric knowledge learned by such models during training. An LLM is an artificial intelligence (AI) model that may be capable of processing and generating human-like text based on the latent information it has learned from vast amounts of training data. The term “large” refers to the size of these models in terms of the number of parameters or weights, which are the values that the model learns during training to make predictions and generate text.

Some embodiments described herein may employ one or more language models (LMs), such as one or more LLMs, in order to process natural language requests and responses. LLMs may have millions, billions (or even more) parameters, which enable such models to capture complex patterns and nuances in language that, in turn, allow the models to understand and generate more natural-sounding text (relative to previous approaches). Examples of LLMs include generative pre-trained transformer models that may be trained for natural language generation tasks, image generation tasks, etc., and even non-generative examples such as BERT (bidirectional encoder representations from Transformers), etc.

In a generative context, an LM may generate text that is responsive to an input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training.

LMs are typically trained on massive datasets that include a wide variety of text from various sources, enabling the LMs to understand grammar, context, and the relationships between words and sentences. In some examples, an LM-based natural language processing flow may generate a prompt from automatic speech recognition (ASR) output data representing a spoken user utterance. The prompt may be fed into the LM. In other examples, a text input (e.g., text typed on a keyboard) may be used as an input prompt (or may be used to generate an input prompt) to the LM. The LM may be trained to output a text-based action plan which may be a formatted into a series of computer-executable actions (including API calls to various subsystems or external platforms and/or devices) that may be taken in order to process the natural language request. An API call refers to sending a request to an API (including any relevant input parameters) of a compute service. In various examples, an LM-based processing flow may be a recursive process wherein the initial action plan may be executed (e.g., by making various API calls to API providers to receive results/responses), and the responses may be used to generate updated LM prompts which may then be input into the LM for generation of an updated action plan.

The one or more user devices 106A-106N, payee devices 108A-108N, and entity devices 110A-110N may be embodied by any computing devices known in the art. The one or more user devices 106A-106N, payee devices 108A-108N, and entity devices 110A-110N need not themselves be independent devices, but may be peripheral devices communicatively coupled to other computing devices. In some embodiments, a user device (e.g., any one of user devices 106A-106N) may be associated with a user who is associated with a new payment account maintained by an entity associated with the onboarding system 102 (e.g., a customer). In some embodiments, a payee device (e.g., any one of payee devices 108A-108N) may be associated with a payee system of a platform with whom the user has an associated user account. A payee system may refer to a user, company, organization, and/or the like. In some embodiments, a payee may provide one or more goods and/or services to the user in exchange for payment. In some embodiments, an entity device (e.g., any one of entity devices 110A-110N) may be associated with a financial institution that maintains a new account (i.e., a selected account) or a former account.

### Example Implementing Apparatuses

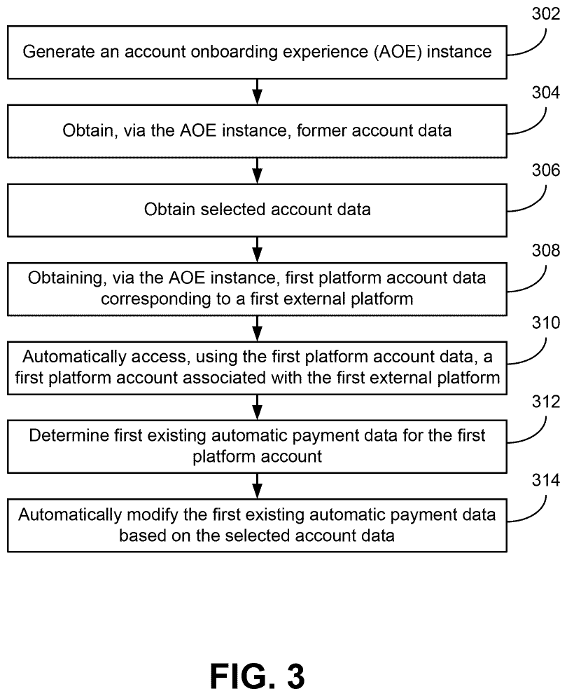

The onboarding system 102 (described previously with reference to FIG. 1) may be embodied by one or more computing devices (e.g., onboarding system device 103) or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, onboarding engine 208, and interface circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an onboarding engine 208 that generates an account onboarding experience (AOE) instance and facilitates user-to-device and device-to-device communication. The onboarding engine 208 may utilize processor 202, memory 204, or any other hardware component included in the apparatus 200 to perform these operations, as described in connection with FIGS. 3-5 below. The onboarding engine 208 may further utilize communications hardware 206 to gather data from a variety of sources (e.g., user devices 106A-106N, payee devices 108A-108N, and/or entity devices 110A-110N, as shown in FIG. 1), and/or exchange data with a user. As described further herein, in various embodiments, an AOE instance comprises a secure and time-bound communication session which facilitates the obtainment of sensitive data (e.g., platform account data, selected account data, former account data, and the like) by the onboarding system 102 from a user device (e.g., any one of user devices 106A-106N). The AOE instance may provide enhanced data security and real-time conversational interactions by combining secure communication protocols and AI-based user interaction.

In addition, the apparatus 200 further comprises interface circuitry 210 that automatically accesses platform accounts, determines existing automatic payment data, and automatically modifies existing automatic payment data. The interface circuitry 210 may utilize processor 202, memory 204, or any other hardware component included in the apparatus 200 to perform these operations, as described in connection with FIGS. 3-5 below. The interface circuitry 210 may further utilize communications hardware 206 to gather data from a variety of sources (e.g., user devices 106A-106N, payee devices 108A-108N, and/or entity devices 110A-110N, as shown in FIG. 1), and/or exchange data with a user. In various embodiments, interface circuitry 210 may comprise various software modules that implement API requests and responses for various third-party platforms. In some embodiments, these software modules may be configured to interact with RESTful (Representational State Transfer) APIs, platform software development kits (SDKs), and the like. Additionally, the interface circuitry 210 may comprise components to manage credential authentication, such as OAuth (open authorization) tokens, API keys, username and password combinations, and the like in order to access platform accounts. As an example, in some embodiments, interface circuitry 210 may generate and cause transmission of requests (e.g., a Hypertext Transfer Protocol Secure (HTTPS) request) to external platforms to perform operations including login, data retrieval, and autopay updates. In some embodiments, interface circuitry 210 may utilize protocols (e.g., Transport Layer Security (TLS)) to protect and encrypt communications between interface circuitry 210 and one or more third-party APIs.

Although components 202-210 are described in part using functional language, it will be understood that the particular implementations necessarily include the use of particular hardware. It should also be understood that certain of these components 202-210 may include similar or common hardware. For example, the onboarding engine 208 and interface circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the onboarding engine 208 and interface circuitry 210 may leverage processor 202, memory 204, or communications hardware 206 as described above, it will be understood that the onboarding engine 208 and/or interface circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that onboarding engine 208 and interface circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3-5, example flowcharts are illustrated that contain example operations implemented by example embodiments described herein. The operations illustrated in FIGS. 3-5 may, for example, be performed by system device 103 of the onboarding system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, onboarding engine 208, interface circuitry 210, and/or any combination thereof. It will be understood that user interaction with the onboarding system 102 may occur directly via communications hardware 206, or may instead be facilitated by a separate user device (e.g., user devices 106A-106N), as shown in FIG. 1, and which may have similar or equivalent physical componentry facilitating such user interaction.

Turning first to FIG. 3, example operations are shown for secure automatic payment modification.

As shown by operation 302, the apparatus 200 includes means, such as processor 202, memory 204, communications hardware 206, onboarding engine 208, and/or the like, for generating an account onboarding experience (AOE) instance. The AOE instance may facilitate communication between a user device and the onboarding system device.

In some embodiments, an AOE instance may be generated in response to user input received by the onboarding system 102 from a user device (e.g., user device 106A). In some embodiments, a user may utilize a mobile application to initiate an AOE instance and communicate with onboarding system 102. In some embodiments, the mobile application may be a mobile banking application associated with a particular financial institution. For example, upon securely logging in to a mobile banking application (e.g., using multi-factor authentication (MFA) including one or more biometric scans (e.g., a facial recognition scan, fingerprint scan, etc.) and/or the like), a user may select a user interface (UI) element via the UI of the mobile banking application related to generating an AOE instance for porting autopayment configurations to a particular account. In some example embodiments, generating the AOE instance may involve re-authenticating the user again to ensure that user requesting the AOE instance is the same user that was previously authenticated when into the mobile banking application. Once the user is re-authenticated, in some embodiments, onboarding engine 208 may generate a session token for the AOE instance that expires in response a timing event, such as user inactivity.

As mentioned above, in various embodiments, an AOE instance comprises a secure and time-bound communication session which facilitates the obtainment of sensitive data (e.g., platform account data, selected account data, former account data, and the like) by the onboarding system 102 from a user device (e.g., user device 106A). The AOE instance may provide enhanced data security and real-time conversational interactions by combining secure communication protocols and AI-based user interaction. In some embodiments, the AOE instance may establish a highly secure connection between the onboarding system 102 and user device (e.g., using TLS encryption) to secure all data communicated between the user device and onboarding system 102.

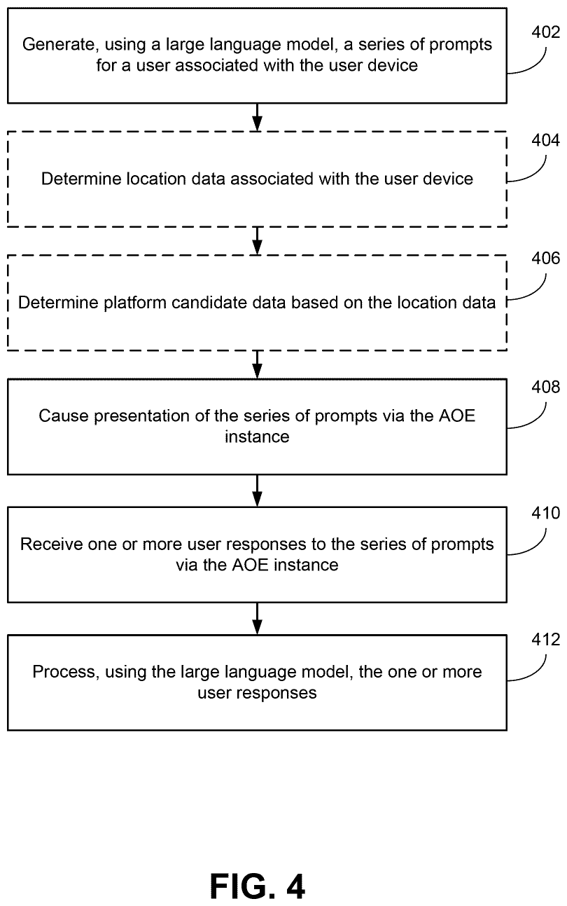

In some embodiments, communication via the AOE instance may be facilitated through conversational prompts generated in connection with a language model 101. In this regard, the user may participate in a user-friendly, casual conversation with onboarding system 102 where the user responds to inquiries intelligently generated through language model 101. Turning to FIG. 4, example operations are shown for facilitating communication via a language model.

As shown by operation 402, the apparatus 200 includes means, such as processor 202, memory 204, communications hardware 206, onboarding engine 208, and/or the like, for generating, using a language model, a series of prompts for a user associated with the user device.

In various embodiments, language model 101 may be used to generate various prompts that include inquiries about what the user wishes to accomplish within the AOE instance. As language model 101 generates prompts, onboarding system 102 may receive metadata associated with the user device 106A in order for the language model 101 to generate relevant prompts for the user. Such metadata may include, for example, location data of the user device. The location data may indicate where the user device is presently located, which may inform onboarding system 102 as to the types of accounts the user may have, and which platforms those user accounts are associated with. In this regard, as shown by operation 404, the apparatus 200 includes means, such as processor 202, memory 204, communications hardware 206, onboarding engine 208, and/or the like, for determining location data associated with the user device. In various embodiments, location data may be determined by processing metadata received from the user device 106A and identifying location data from the metadata. Location data may comprise, for example, location coordinates (e.g., latitude and longitude). In some embodiments, location data may be sent securely to onboarding system 102 as part of context data for the AOE instance. For example, metadata including location data may be encrypted prior to being transmitted to onboarding system 102. In some embodiments, onboarding system 102 may request permission from user device 106A to obtain the location data prior to obtaining location data and/or any other metadata associated with user device 106A.

As shown by operation 406, the apparatus 200 includes means, such as processor 202, memory 204, communications hardware 206, onboarding engine 208, and/or the like, for determining platform candidate data based on the location data. In various embodiments, platform candidate data may comprise a list of platforms that are associated with a location within proximity of a location indicated by the location data. For example, onboarding system 102 may reference a database (e.g., stored in memory 204) of service providers and associated service areas in order to determine platform candidate data. As one example, location data may indicate that the user device is within a particular county of a state within the United States, and the onboarding system 102 may determine one or more service providers that provide services within that county. This may include, for example, a utility company (e.g., an electricity company, a gas company, internet service providers (ISPs), cable television providers, and the like.

In some embodiments, the onboarding system 102 may utilize the platform candidate data to generate one or more prompts using the language model 101. In this regard, a prompt may include the platform candidate data. For example, a prompt may ask the user “I see you are located in Acme county. Do you have an account with ABC Power Company?” after determining that ABC Power Company services the area in which the user device is located. By personalizing prompts using platform candidate data, users may be able to more quickly remember certain platforms for which they have user accounts and autopay configurations for.

As shown by operation 408, the apparatus 200 includes means, such as processor 202, memory 204, communications hardware 206, onboarding engine 208, and/or the like, for causing presentation of the series of prompts via the AOE instance. In various embodiments, causing presentation of the series of prompts via the AOE instance may include visual presentation and/or audio presentation of the series of prompts. For example, onboarding system 102 may leverage a speaker of user device 106A to output the prompt in audio form. In some embodiments, onboarding system 102 may leverage a display of user device 106A to output the prompts visually in a structured, conversational manner.

As shown by operation 410, the apparatus 200 includes means, such as processor 202, memory 204, communications hardware 206, onboarding engine 208, and/or the like, for receiving one or more user responses to the series of prompts via the AOE instance. Continuing with the example above, in response to the prompt “I see you are located in Acme county. Do you have an account with ABC Power Company?” a user may provide a user response. The user response may be input via audio (e.g., the user may speak their response using a microphone of the user device) or as text input (e.g., using a keyboard via the user device 106A). As one example, the user may respond with “Yes.” The language model 101 may then receive the response and generate an additional follow-up prompt. As one example, the additional follow-up prompt may ask the user “Great. I can check to see your current payment configuration with ABC Power Company. What is your username for your account with ABC Power Company?”

As shown by operation 412, the apparatus 200 includes means, such as processor 202, memory 204, communications hardware 206, onboarding engine 208, and/or the like, for processing, by the onboarding engine and using the language model, the one or more user responses. In various embodiments, data may be obtained based on processing user responses. For example, user credentials (e.g., usernames and passwords) may be provided via user responses, as well as account information such as former account data, platform account data, and the like.

In various embodiments, onboarding system 102 (together with language model 101) may process user responses to generate additional prompts dynamically. To do so, language model 101 may parse the user response to extract entities using entity recognition (ER) techniques. For user responses in audio format, the processing may also involve automatic speech recognition (ASR). Automatic speech recognition (ASR) is a field of computer science, artificial intelligence, and linguistics concerned with transforming audio data associated with speech into data (e.g., text or other machine representation data) representative of the words in the speech. Natural language understanding (NLU) is a field of computer science, artificial intelligence, and linguistics concerned with enabling computers to derive meaning from text input containing natural language, resulting in specific executable commands or other type of instructions. Text-to-speech (TTS) is a field of computer science, artificial intelligence, and linguistics concerned with enabling computers to output synthesized speech. ASR, NLU, and TTS may be used together as part of the processing performed by onboarding system 102. NLU processing may include an intent classification process by which intent data is determined that represents the intent (e.g., goal) of the input natural language data (e.g., text). Intent data may be sent to a skill that may, in turn, perform some action based on the intent data. In some examples, language model (LM)-based natural language processing approaches may not use NLU intent classification. For example, LMs (such as large language models (LLMs)) may be effective to semantically interpret natural language inputs using the parametric knowledge learned by such models during training.

While language models are powerful tools capable of understanding and responding to natural language inputs, ER is still needed by LM-based natural language processing systems in order to effectively respond to a natural language request with respect to an appropriate entity. In some examples, a natural language processing flow may employ ER to resolve an entity referenced by the user (e.g., as part of a natural language request) in order generate a prompt to be processed a language model.

In some examples, natural language processing (whether LM-based or other NLU-based) may further include named entity recognition (NER), which is a technique used to identify segments of named entities in text data and to categorize the named entities into various predefined classes. Categorization of named entities into such classes is often referred to as “tagging” the named entities. In this context, “NER tags” are metadata that designates a particular class to a named entity. In text, named entities refer to terms that represent real-world objects such as people, places, organizations, locations, etc., which are often denoted by proper nouns.

In some examples, natural language processing may include entity resolution (ER). Entity resolution refers to disambiguation of an entity (e.g., a named entity in text) according to records stored in memory (e.g., in a database). For example, if text includes the proper noun “London,” ER may be used to perform disambiguation to determine whether to link the named entity to a database entry for London in Ontario or a database entry for London in the United Kingdom. In various examples, the NER classes may be used during ER processing to disambiguate between multiple entities.

Returning to FIG. 3, as shown by operation 304, the apparatus 200 includes means, such as processor 202, memory 204, communications hardware 206, onboarding engine 208, and/or the like, for obtaining, via the AOE instance, former account data. Former account data may comprise data associated with an account that the user wishes to no longer use for one or more autopay configurations for one or more platform accounts. Former account data may relate to a former account that is no longer active or used by the user. Former account data may comprise, for example, an account number, routing number, card number, security code, billing address, and/or similar data for the former account.

In some embodiments, former account data may be obtained via the AOE instance by prompting the user for the former account data using one or more prompts output by the language model 101. For example, a prompt may ask the user “What is the account number for the account you wish to no longer use for automatic payments?” In response, the user may provide an account number for the former account. Additional prompts may be generated and presented at user device 106A in order to get additional account data for the former account.

As shown by operation 306, the apparatus 200 includes means, such as processor 202, memory 204, communications hardware 206, onboarding engine 208, and/or the like, for obtaining selected account data. Selected account data may comprise data associated with a financial account that the user wishes to use for one or more autopay configurations for one or more platform accounts. Selected account data may relate to a new financial account that the user has opened, or to just to a different financial account belonging to the user that is different from the former account. Selected account data may comprise, for example, an account number, routing number, card number, security code, billing address, and/or similar data for the selected account.

In some embodiments, selected account data may be obtained via the AOE instance by prompting the user for the selected account data using one or more prompts output by the language model 101. For example, a prompt may ask the user “What is the account number for the account you wish use for automatic payments?” In response, the user may provide an account number for the selected account. Additional prompts may be generated and presented at user device 106A in order to get additional account data for the selected account.

Alternatively, in some embodiments, selected account data may be automatically determined rather than prompting the user to provide the selected account data. For example, in embodiments in which the onboarding system 102 is associated with a financial institution and the user logs in using their mobile banking application, onboarding system 102 may query one or more entity devices 110A-110N to determine accounts associated with the user and predict which account the user is likely to want to use for autopayment configurations. For example, this may include accounts that have been opened within a recent period of time (e.g., 30 days). In some embodiments, onboarding system 102 may make a determination as to what account is likely to be the selected account and prompt the user to confirm that the determined selected account is indeed the account they wish to port autopay configurations to.

As shown by operation 308, the apparatus 200 includes means, such as processor 202, memory 204, communications hardware 206, onboarding engine 208, and/or the like, for obtaining, via the AOE instance, first platform account data corresponding to a first external platform. In various embodiments, platform account data may comprise data associated with a user account associated with a platform, such as a third-party platform related to provisioning goods or services. For example, platform account data may comprise user login credentials (e.g., a username and password, and/or the like) for a third-party platform such as a television streaming service.

As shown by operation 310, the apparatus 200 includes means, such as processor 202, memory 204, communications hardware 206, interface circuitry 210, and/or the like, for automatically accessing, using the first platform account data, a first platform account associated with the first external platform. For example, in some embodiments, once the first platform account data is received, onboarding system 102 may temporarily store the first platform account data in memory (e.g., memory 204) and then leverage the first platform account data to access a platform account associated with the first platform account data. To do so, interface circuitry 210 may query a database (e.g., stored in memory 204) that includes API specifications for a plurality of different platforms. The API specifications stored by the database may include data regarding required headers, payload structures, and the like for APIs of different platforms. The database may be queried using the name of the platform provided by the user in response to a prompt in order to identify a corresponding API specification.

The interface circuitry 210 may then generate an API request to login that includes the first platform account data (e.g., a username and password) and send the request over a secured connection. In response, in some embodiments, the onboarding system 102 may receive a token (e.g., an access token, a session token, and/or the like) which may then be stored in memory 204 and used for any additional API calls to that platform. In some embodiments, interface circuitry 210 may then retrieve current autopay data for the platform account by generating another API request, which may result in receiving a response that includes data about the first existing automatic payment data including a linked payment method (e.g., an account number, card number, and/or the like). In this regard, as shown by operation 312, the apparatus 200 includes means, such as processor 202, memory 204, communications hardware 206, interface circuitry 210, and/or the like, for determining first existing automatic payment data for the first platform account.

As shown by operation 314, the apparatus 200 includes means, such as processor 202, memory 204, communications hardware 206, interface circuitry 210, and/or the like, for automatically modifying the first existing automatic payment data based on the selected account data. For example, in some embodiments, the interface circuitry 210 may determine whether to update the existing payment data with the selected account data. In some examples, this may be a determination based on matching. For example, if the existing payment data does not match the selected account data, interface circuitry 210 may automatically modify the first existing automatic payment data by changing it to the selected account data. However, if the existing payment data does match the selected account data, the interface circuitry 210 may not modify the existing payment data, and instead instruct onboarding engine 208 to generate a prompt that lets the user know that the autopay configuration for that platform account already reflects the selected account data.

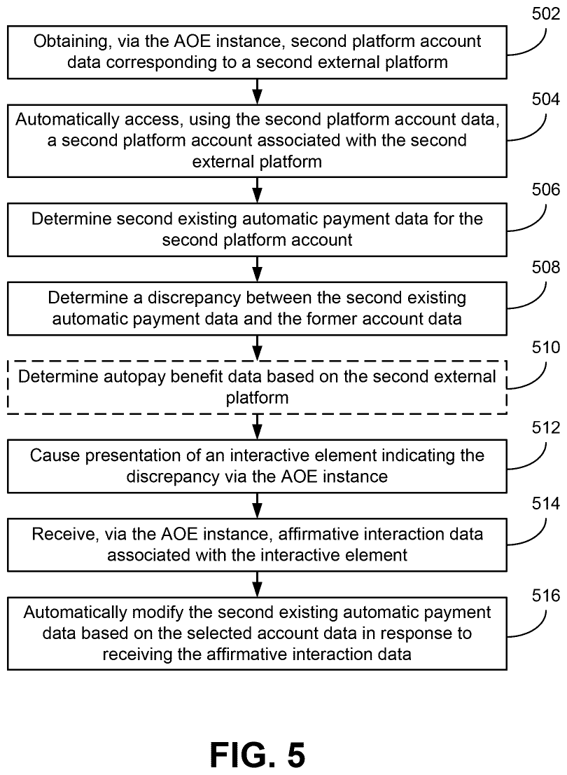

In some embodiments, onboarding system 102 may make additional determinations prior to modifying existing automatic payment data. Turning now to FIG. 5, example operations are shown for secure automatic payment modification.

As shown by operation 502, the apparatus 200 includes means, such as processor 202, memory 204, communications hardware 206, onboarding engine 208, and/or the like, for obtaining, via the AOE instance, second platform account data corresponding to a second external platform.

In various embodiments, second platform account data may comprise data associated with a user account associated with a second platform, such as a third-party platform related to provisioning goods or services, which is different from the first platform. In this regard, a user may provide multiple sets of platform account data for a plurality of different platforms via the AOE instance.

As shown by operation 504, the apparatus 200 includes means, such as processor 202, memory 204, communications hardware 206, interface circuitry 210, and/or the like, for automatically accessing, using the second platform account data, a second platform account associated with the second external platform. For example, in some embodiments, once the second platform account data is received, onboarding system 102 may temporarily store the second platform account data in memory (e.g., memory 204) and then leverage the second platform account data to access a platform account associated with the second platform account data. To do so, as described above, interface circuitry 210 may query a database (e.g., stored in memory 204) that includes API specifications for a plurality of different platforms.

The interface circuitry 210 may then generate an API request to login that includes the second platform account data (e.g., a username and password) and send the request over a secured connection. In response, in some embodiments, the onboarding system 102 may receive a token (e.g., an access token, a session token, and/or the like) which may then be stored in memory 204 and used for any additional API calls to that platform. In some embodiments, interface circuitry 210 may then retrieve current autopay data for the platform account by generating another API request, which may result in receiving a response that includes data about the existing automatic payment data including a linked payment method (e.g., an account number, card number, and/or the like) for the second platform account. In this regard, as shown by operation 506, the apparatus 200 includes means, such as processor 202, memory 204, communications hardware 206, interface circuitry 210, and/or the like, for determining second existing automatic payment data for the second platform account.

As shown by operation 508, the apparatus 200 includes means, such as processor 202, memory 204, communications hardware 206, interface circuitry 210, and/or the like, for determining a discrepancy between the second existing automatic payment data and the former account data. For example, the interface circuitry 210 may determine whether the existing automatic payment data corresponds to (e.g., matches) the former account data. If the former account data does not correspond to the existing automatic payment data, the interface circuitry 210 may determine that a discrepancy exists. In this regard, in some embodiments, the onboarding system 102 may revert back to the user device 106A in the event of a discrepancy between the existing automatic payment data and former account data. For example, while a user may wish to update platform accounts with selected account data to move away from a former account, they may be under the impression that the second platform account is configured for autopay with the former account. However, this may not be the case. For example, the second platform account may be configured for autopay with a different instrument, such as a credit card that is not related to the former account. Some individuals may configure automatic payments with credit cards as to reap certain rewards for doing so (e.g., cashback on purchases, etc.). In this event, for example, a user may wish for the credit card to remain as the autopay method for the second platform account.

As shown by operation 510, the apparatus 200 includes means, such as processor 202, memory 204, communications hardware 206, onboarding engine 208, interface circuitry 210, and/or the like, for determining autopay benefit data based on the second external platform. In some embodiments, certain platforms may incentivize customers for configuring autopay with a direct credit of their checking account, such as linking a bank account through Automated Clearing House (ACH) transfer rather than having a credit or debit card on file. For example, customers may qualify for a small monthly discount for services by having autopay linked to a checking account number rather than a credit card number. In some embodiments, autopay benefit data may comprise a data structure that indicates whether or not some benefit exists that is related to autopay for that particular platform. To determine autopay benefit data, onboarding system 102 may reference a database (e.g., stored in memory 204) of known autopay benefits corresponding a plurality of platforms. The database may be queried using the name of the platform provided by the user in response to a prompt in order to identify any corresponding autopay benefit data.

As shown by operation 512, the apparatus 200 includes means, such as processor 202, memory 204, communications hardware 206, onboarding engine 208, and/or the like, for causing presentation of an interactive element indicating the discrepancy via the AOE instance. In some example embodiments, the interactive element may comprise a prompt (e.g., generated using language model 101) and a set of selectable buttons or links. For example, a prompt may be generated which asks the user “I see you actually have an account linked to autopay that is different from your former account. Would you still like to update the autopay for this account with your new account?” with selectable “yes” and “no” buttons displayed in line with the prompt. In some embodiments, the interactive element may also indicate autopay benefit data (if autopay benefit data exists for the particular platform account). Continuing with the example above, the prompt may be rephrased to “I see you actually have an account linked to autopay that is different from your former account. This service provider offers a $5 monthly discount when linking a checking account to autopay. Would you still like to update the autopay for this account with your new account?” if it is determined that there is autopay benefit data associated with the platform account.

As shown by operation 514, the apparatus 200 includes means, such as processor 202, memory 204, communications hardware 206, onboarding engine 208, and/or the like, for receiving, via the AOE instance, affirmative interaction data associated with the interactive element. In this regard, affirmative interaction data may indicate that the user selected “yes” to update the second existing automatic payment data. In some embodiments, if negative interaction data is received (e.g., the user selected “no”), the onboarding system 102 may take no further action.

As shown by operation 516, the apparatus 200 includes means, such as processor 202, memory 204, communications hardware 206, interface circuitry 210, and/or the like, for automatically modifying the second existing automatic payment data based on the selected account data in response to receiving the affirmative interaction data. In some embodiments, to modify existing automatic payment data, interface circuitry 210 may generate a request that includes a payload comprising the selected account data (e.g., account number or card number, expiration date, security code, billing address, first and last name, and/or any other required information) and execute an API call to the platform (e.g., payee device 108A).

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable secure automatic payment modification. Example embodiments thus provide tools that overcome the problems traditionally experienced by individuals wishing to port existing automatic payment configurations to new or different accounts. As described herein, through automating payment configuration updates, the onboarding system improves interaction between both devices and users, significantly reduces computational overhead and user cognitive load, and enables a scalable multi-account management experience through a user-friendly and LM-based conversational user interface.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
generating, by an onboarding engine of an onboarding system device, an account onboarding experience (AOE) instance, wherein the AOE instance facilitates communication between a user device and the onboarding system device;
obtaining, by communications hardware of the onboarding system device and via the AOE instance, former account data;
obtaining, by the communications hardware of the onboarding system device, selected account data;
obtaining, by the communications hardware of the onboarding system device and via the AOE instance, first platform account data corresponding to a first external platform;
automatically accessing, by interface circuitry and using the first platform account data, a first platform account associated with the first external platform;
determining, by the interface circuitry, first existing automatic payment data for the first platform account; and
automatically modifying, by the interface circuitry, the first existing automatic payment data based on the selected account data.

2. The method of claim 1, wherein determining the first existing automatic payment data for the first platform account comprises:
determining, by the interface circuitry, that the first existing automatic payment data corresponds to the former account data,
wherein the first existing automatic payment data is automatically modified based on the selected account data in response to determining that the first existing automatic payment data corresponds to the former account data.

3. The method of claim 2, further comprising:
obtaining, by the communications hardware of the onboarding system device and via the AOE instance, second platform account data corresponding to a second external platform;
automatically accessing, by the interface circuitry and using the second platform account data, a second platform account associated with the second external platform;
determining, by the interface circuitry, second existing automatic payment data for the second platform account;
determining, by the interface circuitry, a discrepancy between the second existing automatic payment data and the former account data; and
causing, by the communications hardware, presentation of an interactive element indicating the discrepancy via the AOE instance.

4. The method of claim 3, further comprising:
determining, by the interface circuitry, autopay benefit data based on the second external platform,
wherein the interactive element further indicates the autopay benefit data.

5. The method of claim 3, further comprising:
receiving, by the communications hardware and via the AOE instance, affirmative interaction data associated with the interactive element; and
automatically modifying, by the interface circuitry, the second existing automatic payment data based on the selected account data in response to receiving the affirmative interaction data.

6. The method of claim 1, further comprising:
generating, by the onboarding engine and using a language model, a series of prompts for a user associated with the user device;
causing, by the communications hardware, presentation of the series of prompts via the AOE instance;
receiving, by the communications hardware, one or more user responses to the series of prompts via the AOE instance; and
processing, by the onboarding engine and using the language model, the one or more user responses,
wherein at least the former account data and the first platform account data are obtained based on processing the one or more user responses.

7. The method of claim 6, further comprising:
determining, by the onboarding engine, location data associated with the user device; and
determining, by the onboarding engine, platform candidate data based on the location data,
wherein at least one prompt of the series of prompts includes the platform candidate data.

8. A system comprising:
an onboarding engine of an onboarding system device configured to generate an account onboarding experience (AOE) instance, wherein the AOE instance facilitates communication between a user device and the onboarding system device;
communications hardware of the onboarding system device configured to:
obtain, via the AOE instance, former account data,
obtain selected account data, and
obtain, via the AOE instance, first platform account data corresponding to a first external platform; and
interface circuitry configured to:
automatically access, using the first platform account data, a first platform account associated with the first external platform,
determine first existing automatic payment data for the first platform account, and
automatically modify the first existing automatic payment data based on the selected account data.

9. The system of claim 8, wherein the interface circuitry is configured to determine the first existing automatic payment data for the first platform account by:
determining that the first existing automatic payment data corresponds to the former account data,
wherein the first existing automatic payment data is automatically modified based on the selected account data in response to determining that the first existing automatic payment data corresponds to the former account data.

10. The system of claim 9, further comprising:
wherein the communications hardware is further configured to obtain, via the AOE instance, second platform account data corresponding to a second external platform;
wherein the interface circuitry is further configured to:
automatically access, using the second platform account data, a second platform account associated with the second external platform,
determine second existing automatic payment data for the second platform account,
determine a discrepancy between the second existing automatic payment data and the former account data; and
wherein the communications hardware is further configured to cause presentation of an interactive element indicating the discrepancy via the AOE instance.

11. The system of claim 10, wherein the interface circuitry is further configured to determine autopay benefit data based on the second external platform,
wherein the interactive element further indicates the autopay benefit data.

12. The system of claim 10, further comprising:
wherein the communications hardware is further configured to receive, via the AOE instance, affirmative interaction data associated with the interactive element; and
wherein the interface circuitry is further configured to automatically modify the second existing automatic payment data based on the selected account data in response to receiving the affirmative interaction data.

13. The system of claim 8,
wherein the onboarding engine is further configured to generate, using a language model, a series of prompts for a user associated with the user device;
wherein the communications hardware is further configured to:
cause presentation of the series of prompts via the AOE instance, and
receive one or more user responses to the series of prompts via the AOE instance; and
wherein the onboarding engine is further configured to process, using the language model, the one or more user responses,
wherein at least the former account data and the first platform account data are obtained based on processing the one or more user responses.

14. The system of claim 13, wherein the onboarding engine is further configured to:
determine location data associated with the user device, and determine platform candidate data based on the location data,
wherein at least one prompt of the series of prompts includes the platform candidate data.

15. A computer program product comprising at least one non-transitory computer-readable storage medium storing software instructions that, when executed, cause an apparatus to:
generate an account onboarding experience (AOE) instance, wherein the AOE instance facilitates communication between a user device and an onboarding system device;
obtain, via the AOE instance, former account data;
obtain selected account data;
obtain, via the AOE instance, first platform account data corresponding to a first external platform;
automatically access, using the first platform account data, a first platform account associated with the first external platform;
determine first existing automatic payment data for the first platform account; and
automatically modify the first existing automatic payment data based on the selected account data.

16. The computer program product of claim 15, further comprising software instructions that, when executed, cause the apparatus to:
determine that the first existing automatic payment data corresponds to the former account data,
wherein the first existing automatic payment data is automatically modified based on the selected account data in response to determining that the first existing automatic payment data corresponds to the former account data.

17. The computer program product of claim 16, further comprising software instructions that, when executed, cause the apparatus to:
obtain, via the AOE instance, second platform account data corresponding to a second external platform;
automatically access, using the second platform account data, a second platform account associated with the second external platform;
determine second existing automatic payment data for the second platform account;
determine a discrepancy between the second existing automatic payment data and the former account data; and
cause presentation of an interactive element indicating the discrepancy via the AOE instance.

18. The computer program product of claim 17, further comprising software instructions that, when executed, cause the apparatus to:
determine autopay benefit data based on the second external platform,
wherein the interactive element further indicates the autopay benefit data.

19. The computer program product of claim 17, further comprising software instructions that, when executed, cause the apparatus to:
receive, via the AOE instance, affirmative interaction data associated with the interactive element; and
automatically modify the second existing automatic payment data based on the selected account data in response to receiving the affirmative interaction data.

20. The computer program product of claim 15, further comprising:
generate, using a language model, a series of prompts for a user associated with the user device;
cause presentation of the series of prompts via the AOE instance;
receive one or more user responses to the series of prompts via the AOE instance; and
process, using the language model, the one or more user responses,
wherein at least the former account data and the first platform account data are obtained based on processing the one or more user responses.
